(19) United States
(12) Patent Application Publication
(10) Pub. No.: US 2012/0289429 A1
(43) Pub. Date: Nov. 15, 2012

(54) BIOCHIP COMPRISING MULTIPLE MICROCHANNELS

(75) Inventors: Hong CHEN, Xiamen (CN); Xiangmeng Qu, Xiamen (CN)

(73) Assignee: XIAMEN UNIVERSITY, Xiamen (CN)

(21) Appl. No.: 13/553,832

(22) Filed: Jul. 20, 2012

Related U.S. Application Data
(63) Continuation of application No. PCT/CN2011/000918, filed on May 31, 2011.

(30) Foreign Application Priority Data
Jun. 1, 2010 (CN) 201010193890.4
Jun. 1, 2010 (CN) 201010193906.1
Jun. 1, 2010 (CN) 201010193922.0

(51) Int. Cl. C40B 40/06; C40B 30/04; C40B 40/00; C40B 40/10; C40B 40/02; C40B 40/12

(52) U.S. Cl. 506/9; 506/16; 506/14; 506/19; 506/13; 506/18

(57) ABSTRACT

A biochip includes a plurality of microchannels; and a plurality of probes disposed in an inner wall of each of the plurality of microchannels forming a one-dimensional array. The one-dimensional array of probes are configured to react with a sample in the microchannel. The plurality of microchannels are arranged such that the plurality of probes of the plurality of microchannels form a two-dimensional or three-dimensional array.

### CROSS-REFERENCE TO RELATED APPLICATIONS

The present application is a continuation of PCT/CN2011/000918, filed on May 31, 2011, which claims priority to Chinese Patent Application No. 201010193906.1, entitled “A manufacturing method for a capillary channel probe array used in biochip analysis,” No. 201010193922.0, entitled “A high throughput hybridizing method for a biochip,” and No. 201010193890.4, entitled “A manufacturing method for a microfluidic channel array used for biochip analysis,” all filed on Jun. 1, 2010. The disclosures of the above applications are hereby incorporated by reference in their entirety.

### BACKGROUND

Biochip immobilizes a large number of biological molecules or materials (such as nucleic acid, proteins, drugs, receptors, cell or tissue, etc.) on the substrate's surface to form a well patterned array. Those molecules or materials acting as the probes hybridize or react specifically with the sample, to obtain the sample's information. Thousands of reactions may be carried out on a single chip simultaneously, which are capable of the large-scale parallel analysis. Generally, the biochip may be prepared on the substrate such as glass, silicon and nylon film. The probe array may be prepared by spotting (Schena M, Shalon D, Davis R W, et al. Science, 1995, 20: 467-470) or in situ synthesis (Fodor S P A, Read J L, Pirrung M C, et al. Science, 1991, 251: 767-773). The sample can then be added to hybridize with the probe array and got detected (Fan J P, Chinese Journal of Medical Physics, 2009, 26: 1115-1117). The spotting instrument spots the probe solution onto the substrate's surface by spotting pin, and then the probe immobilizes onto the substrate's surface by covalent bonding. The in situ synthesis is usually used for the preparation of oligonucleotide array. By using standard 3-nitrophenylpropyloxycarbonyl photolabile chemistry, nucleotide monomer is coupled to the end of the oligonucleotide. By repeating these steps, the probe may be extended to a certain length and completes the preparation of probe array.

### SUMMARY

In an aspect, an array of microchannels is provided, including: at least one microchannel; and a plurality of probes disposed in an inner wall of the microchannel forming a one-dimensional array, wherein the one-dimensional array of probes are configured to react with a sample in the microchannel.

In some embodiments, the array comprises a plurality of microchannels forming a two-dimensional array of probes.

In some implementations, the two-dimensional probes array form a three-dimensional array of probes, and wherein the multiple microchannels are perpendicular to a same surface.

In some implementations, the sample may be a single type of sample filling the microchannel for reaction with the plurality of probes. After the reaction, the plurality of probes may be recovered, and may be used for reaction with another type of sample. In some other implementations, the sample may include a plurality of different samples comprising a sequence of droplets configured to react respectively with the plurality of probes, and the droplets.

In some implementations, the sequence of droplets contain different types of samples, wherein the at least one microchannel comprises different probes, and wherein the sequence droplets and the different probes are configured to have one-to-one mapping in the microchannel.

In some implementations, the microchannel comprises a microfluidic channel or a capillary channel.

In some implementations, the probes and the sample comprise at least one of nucleic acids, oligonucleotides, proteins, peptides, peptide-nucleic acids, oligosaccharides, antigens, immunoglobulins, ligand, receptor, drug, cells, organelles, cell fragments, small molecules, and chimeric molecules.

In some implementations, the microchannel is composed of glass, polymer, or semiconductor.

In another aspect, a biochip is provided including: a plurality of microchannels; and a plurality of probes disposed in an inner wall of each of the plurality of microchannels forming a one-dimensional array, wherein the one-dimensional array of probes are configured to react with a sample in the microchannel, and wherein the plurality of microchannels are arranged such that the plurality of probes of the plurality of microchannels form a two-dimensional or three-dimensional array.

In some implementations, the plurality of microchannels comprise at least one of a microfluidic channel or a capillary channel.

In some implementations, the probes and the sample comprise at least one of nucleic acids, oligonucleotides, proteins, peptides, peptide-nucleic acids, oligosaccharides, antigens, immunoglobulins, ligand, receptor, drug, cells, organelles, cell fragments, small molecules, and chimeric molecules.

In some implementations, the microchannel is composed of glass, polymer, or semiconductor.

In another aspect, a method is provided including: introducing an array of probes droplets into a microchannel from an inlet of a microchannel; immobilizing the probes onto an inner surface of the microchannel to form a one-dimensional array of probes; and flowing a sample solution through the microchannel to hybridize with the probes.

In some implementations, said immobilizing comprises washing and drying.

In some implementations, said flowing a sample solution comprises hybridization between the sample solution with respective probes.

In some implementations, the method further comprises de-associating and eliminating the hybridized sample by denaturation, demagnetization, changing of the PH, solution concentration, etc.

In some implementations, the method further comprises flowing another sample solution through the microchannel and re-hybridizing with a re-generated probes array.

In some implementations, wherein at least one of said introducing or said flowing is based on a microfluidic pumping action or a capillary action.

In some implementations, wherein said introducing comprises introducing the array of probes droplets separated by an immiscible solvent.

In some implementations, wherein the immiscible solvent comprises an organic solution or ionic liquid.

### BRIEF DESCRIPTION OF DRAWINGS

FIG. 1 is a schematic view showing the preparation of probe array on capillary's inner wall.

FIG. 2 is a schematic view showing the preparation of probe arrays on multiple capillaries' inner wall.

FIG. 3 is a schematic view showing the preparation of probe array in the capillary with a syringe as the driving force.

FIG. 4 is a schematic view showing the preparation of probe array in the microfluidic chip.

FIG. 5 is a schematic view showing the preparation of probe arrays in the multiple microchannels of microfluidic chip.

FIG. 6 is a schematic view showing the preparation of probe array in a spiral microchannel of microfluidic chip.

FIG. 7 is a schematic view showing the preparation of probe array in the microfluidic chip with a short capillary as sample tip.

FIG. 8 is a schematic view showing the preparation of probe array in microfluidic chip with the syringe as driving force.

FIG. 9 is a diagram showing the fluorescence intensity of immobilized probe. In FIG. 9, the horizontal axis represents the probe concentration (μm), and the vertical axis represents the fluorescence intensity.

FIG. 10 is a schematic view showing the sample's hybridization with the probe array inside the capillary.

FIG. 11 is a schematic view showing the sample's hybridization with the probe arrays in multiple capillaries.

FIG. 12 is a schematic view showing the sample's hybridization in the capillary with the syringe as driving force.

FIG. 13 is a diagram showing that fluorescence intensity of hybridization spots, two oligo samples with different concentration hybridized with the probe arrays. In FIG. 13, the X axis is the sample concentration (nM), the Y axis is the fluorescence intensity. Two oligo samples (a and b) are CLN1′ and CLN5′ respectively.

FIG. 14 is a schematic view showing the sample's hybridization with the probe array in the microfluidic chip.

FIG. 15 is a schematic view showing the sample's hybridization with the probe arrays in the multiple microchannels of microfluidic chip.

FIG. 16 is a schematic view showing the sample's hybridization with the probe array in the spiral microchannel of microfluidic chip.

FIG. 17 is a schematic view showing the sample's hybridization in the microfluidic chip with a short capillary as sample tip.

FIG. 18 is a schematic view showing the sample's hybridization in the microfluidic chip with the syringe as driving force.

FIG. 19 is a diagram showing that fluorescence intensity of hybridization, two probes with different concentration were immobilized and hybridized with two samples. In FIG. 19, the X axis is the probe concentration (μM), the Y axis is the fluorescence intensity. Two probes (a and b) are ALN1 and ALN5 respectively.

FIG. 20 is a schematic view showing the preparation of the probe arrays in a three-dimensional array consisted of multiple capillaries.

FIG. 21 is a schematic view showing the preparation of the probe array in a three-dimensional array consisted of microfluidic chips with multiple microchannels.

FIG. 22 is a schematic view showing that array consisted of standing capillaries, which can be used for probe's immobilization and sample's hybridization

FIG. 23 is a schematic view showing that array consisted of standing microfluidic chips, which can be used for probe's immobilization and sample's hybridization

### DETAILED DESCRIPTION

Conventional methods may require sophisticated techniques, and have high production cost, long preparing time, and may need sophisticated and expensive instruments. The hybridization time of the biochip is also relatively long, from several hours to over ten hours. Usually, one probe array is only used for the detection of one sample, it is very difficult to detect multiple samples with low cost, high throughput and fast detection feasibilities.

The capillary is a simple tube with the very low cost. It will facilitate the fabrication and reduce the cost if the capillary is used to prepare the biochip. The hybridization of the conventional microarray is limited by the diffusion, and usually takes dozens of hours. The hybridization inside the microchannel will be accelerated by the short diffusion distance and flowing hybridization. The hybridization with short time, enhanced signal and high sensitivity can be realized (Benn J A, Hu J, Hogan B J, et al. Anal. Biochem., 2006, 348: 284-293).

The patent for utility model (Bulletin No. CN2483395Y) disclosed a capillary based microarray, which mounted a filament in a transparent capillary. The filament was spotted with probe, marker, positive control and negative control, and inserted into a capillary. The sample flew into the capillary by capillary force and soaked the filament. The sample hybridized with the probe array to realize the detection. The probe array was prepared on the filament, not the inner surface of the capillary. The probe number was limited and can only be used for one sample. Multiple biochips were needed to detect multiple samples.

Microfluidic chip uses a variety of micro-fabrication technologies to fabricate the miniature structures on the substrate. The miniature structures are integrated together to realize certain functions, such as reaction, separation, detection and so on. The purpose of microfluidic chip is realizing integrated, automatic and miniature device in a small chip. In the early 1990s, the microfluidic chip was first reported by Manz and Widmer (Manz A, Graber N, Widmer H M. Sens. Actuators, B, 1990, B1:244).

After the rapid development for many years, the microfluidic chip has been applied not only in analytical chemistry, but also in the other fields including DNA, protein and cell. Carrying out the hybridization in the microfluidic chip, it may reduce the cost, decrease the hybridization time, enhance signal and improve the sensitive (Chen H, Wang L, Li P C H, Lab Chip, 2008, 8: 826-829). The hybridization time in microfluidic chip has been decreased to 5 min (Wang L, Li P C H, J. Agric. Food Chem.; 2007, 55: 10509-10516), but the probe array still only be used for one hybridization.

Other issues may include that the probe array is not tolerant to the high temperature, so that the microfluidic chip can not be irreversible bonding. It brings many difficulties in the fabrication, operation, integration and application. And the microchannel need to be aligned with the probe array by hand, the probe array must be duplicated to ensure the enough probes are included in the microchannel. This also decreased the array's spot density and probe number.

Embodiments disclosed herein may provide a method capable of high throughput biochip analysis. In an example, the following operations may be included:

1. An array of probes droplets is introduced into the microchannel of the microfluidic chip or capillary, the droplets are separated by organic phase as the carrier fluid.

2. After the droplets array has been generated, stop the flowing of droplets array. The probe in the droplets immobilizes onto the inner wall of capillary by covalently bonding or physical absorption. The immobilization may happen spontaneously with or may be triggered by light, electricity or magnetism. After the immobilization, the droplets array and carrier are washed away by the buffer.

3. Introduce the sample solution into the microchannel.

4. The sample hybridizes with the probe array inside the microchannel. The sample binds to the probe with the complementary sequence by affinity reaction. The sample's sequence or information can be obtained by the probe which the sample binds to.

5. The sample has been labeled by the markers. The markers may be universal sequence tags, and may include, for example, bar code tags, fluorescent markers, quantum dot, photonic crystal, Raman tags, IR tags, Electrochemical markers. The sample is detected by whether the sample is retained in the probe region.

6. After detection, denaturation method is carried out to elute the sample from the probe, and regenerates the probe array.

7. Another sample is introduced into the capillary, hybridizes with the probe array and get detected again. By repeating the denaturation-hybridization cycle, high throughput multiple samples detection is realized in this capillary based biochip.

In the step 1, wherein the introducing of the probe droplets array into the microchannel. The sample tip of the microchannel is inserted into a reservoir or a tube to introduce the solution into the microchannel. The microchannel is a part of capillary or microfluidic chip. The capillary is subject to but not limited by glass capillary, fused silica capillary or polymer capillary. The diameter of capillary ranges from 1 nm to 5 cm. The capillary can be one capillary or multiple capillaries in series or parallel. The microfluidic chip is prepared by glass, quartz, silicon or polymer. The dimension of microchannel ranges from 1 nm to 5 cm. The microchannel can be straight channel, serpentine channel, square channel or spiral channel. The microchannel can be one channel or multiple channels in parallel.

In the steps 1, 2, 3, 4, the driving force of the solution flowing inside the microchannel may be subject to but not limited by the electric field, capillary force, surface tension, syringe pump or gravity.

In the step 5, the detection may be realized by the labeling of sample. In the step 6, wherein the denaturation method is subject to but not limited by thermal denaturation, extreme pH treatment, ionic strength-dependent denaturation and denaturation reagent treatment.

In the step 6, the probe and sample may be subject to but not limited by nucleic acid/small molecules, peptides, protein, antigen, polysaccharide, ligand, drug, receptor, cell and tissue etc.

Advantages of at least some of the disclosed implementations may include: preparation of the probe array inside the closed microchannel with reduced reagent consuming; the probe array with different densities can be achieved; hybridization is carried out inside the microchannel, realizing the fast detection of sample; multiple samples can be detected by one capillary or microfluidic chip by repeating the denaturation-hybridization cycle; reduce the dependence on the expansive instruments, decrease the cost during the preparation and analysis; accelerate the processes of preparation and analysis, realizing the low cost and high throughput biochip analysis.

The following embodiments are described in more detail with reference to the drawings.

### Embodiment 1

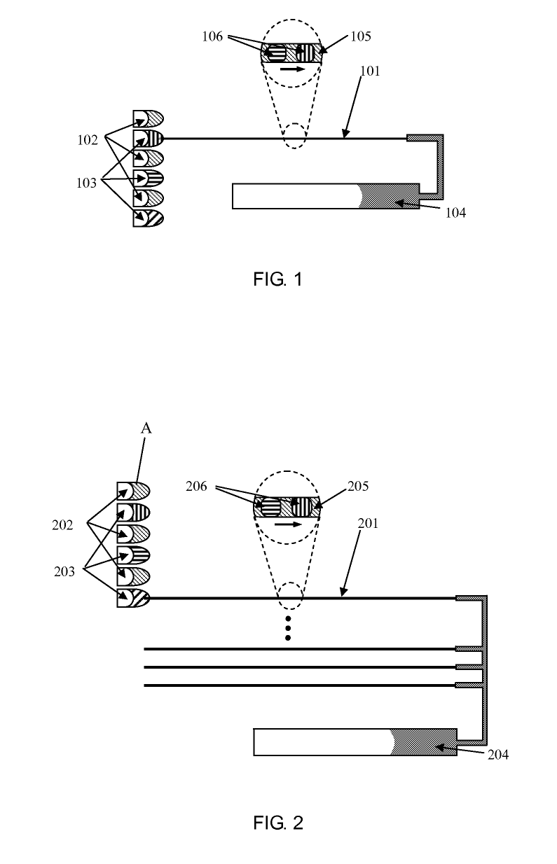

As shown in FIG. 1, one end of the capillary 101 is inserted into tube A as a sample tip, the tubes A containing mineral oil 102 and probe 103 are arranged alternately. Another end of the capillary 101 is connected with a reservoir 104, and the carrier 105 and droplets array 106 are flowing along the capillary 101 with the gravity as driving force. When the droplets array is generated, stop flowing and immobilize the probe to complete the preparation of the probe array along the capillary 101.

### Embodiment 2

As shown in FIG. 2, capillary array 201 is consisted of multiple parallel capillaries. Each capillary has one inlet and one outlet, parallel probe arrays are prepared in capillaries and used for parallel biochip analysis.

### Embodiment 3

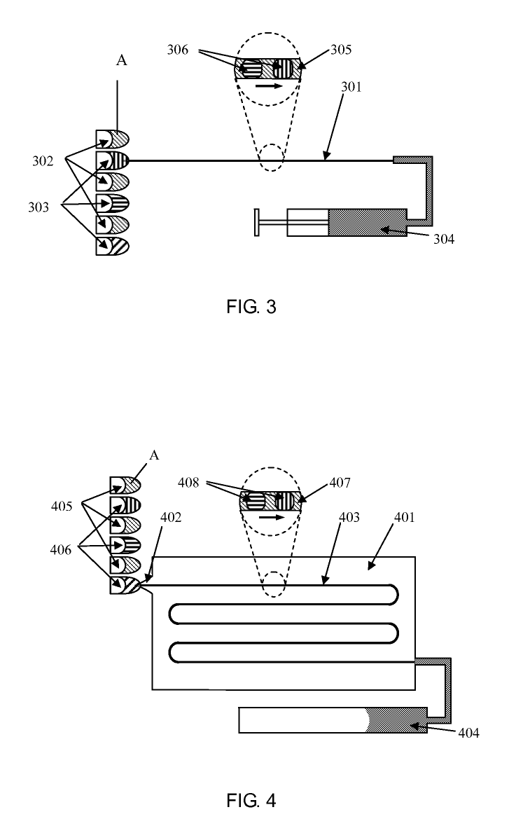

As shown in FIG. 3, the outlet of capillary 301 is connected with a syringe, and the flowing of the droplet array along the capillary 301 is driving by the syringe.

### Embodiment 4

As shown in FIG. 4, the microfluidic chip 401 comprises a spiral microchannel 403. The inlet of microchannel 403 is machined into a sharp needle, and inserted into the tube A. the tubes A containing mineral oil 405 and probe 406 are arranged alternately. The outlet of microchannel is connected with a reservoir 404, and the carrier 407 and droplets array 408 are flowing along the microchannel 403 with the gravity as driving force. When the droplets array is generated, stop flowing and immobilize the probe to complete the preparation of the probe array along the microchannel 403.

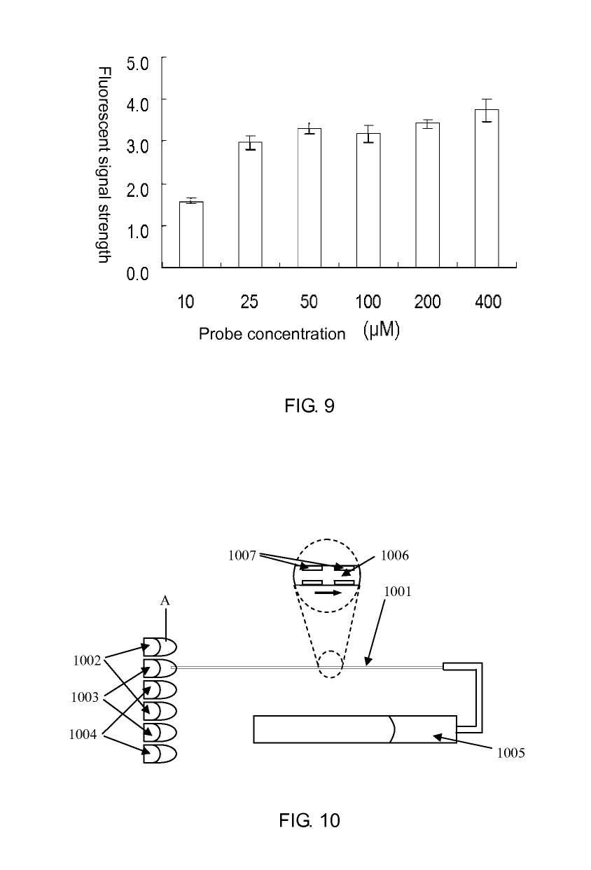

FIG. 9 illustrates the fluorescence intensity of different concentration probe after 30 min immobilization. The probes may be 20 base pairs long, and may be labeled with FITC group at their 3 end and amino group at their 5 end. The microchannel is modified by glutaraldehyde, and the probe is immobilized by the reaction between the probe's amino group and aldehyde group of glutaraldehyde.

### Embodiment 5

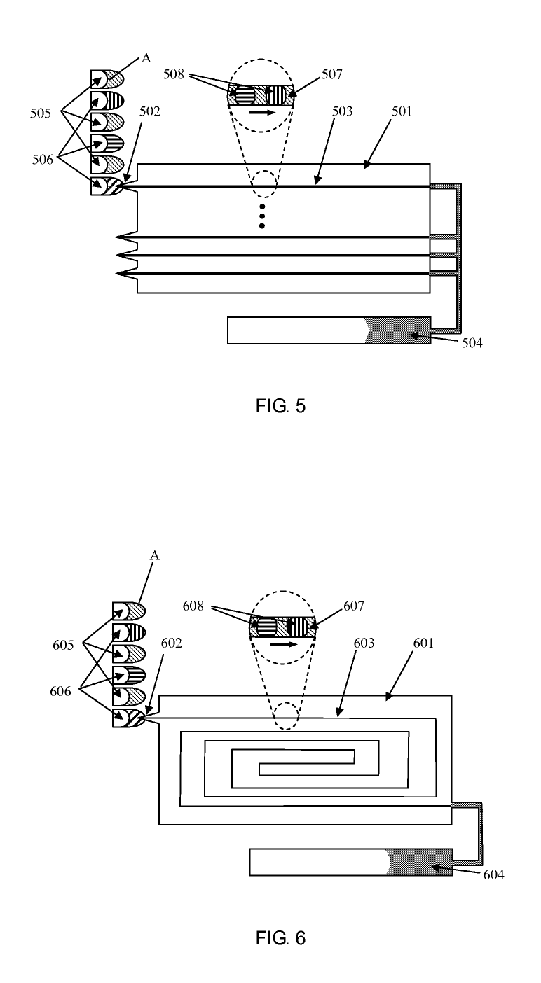

As shown in FIG. 5, the microfluidic chip 501 comprises one or multiple microchannels 503. Each microchannel 503 has one inlet and one outlet, parallel probe arrays are prepared in the parallel microchannels 503 and used for parallel biochip analysis.

### Embodiment 6

As shown in FIG. 6, the spiral microchannel 603 of microfluidic chip 601 is used for the preparation of probe array.

### Embodiment 7

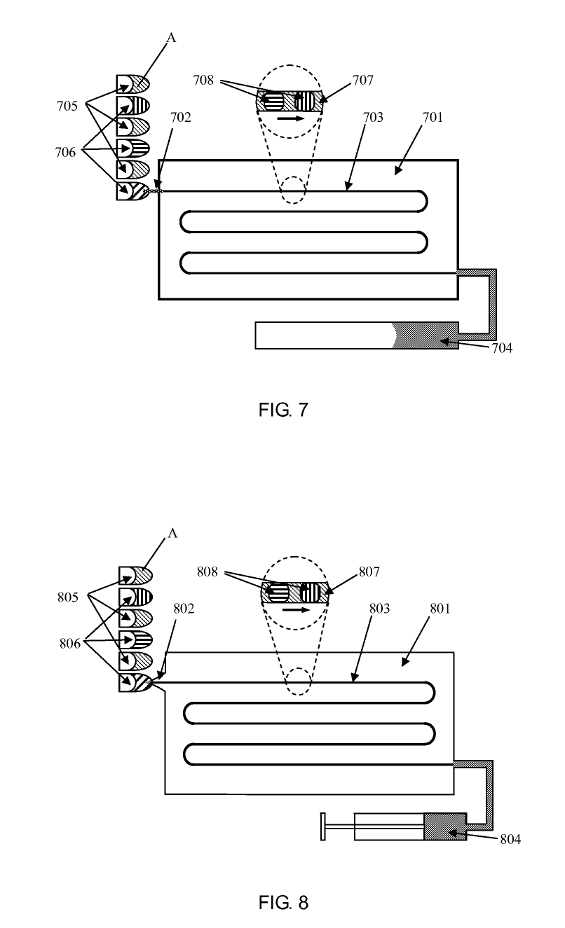

As shown in FIG. 7, the inlet of microchannel 703 is replaced by a short capillary 702. The method is listed below: drill a small hole at the inlet of microchannel 703, then insert a short capillary 702 into the hole and fix with glue.

### Embodiment 8

As shown in FIG. 8, the outlet of the microchannel 803 is connected with a syringe 804. The droplets array is driven flowing inside the microchannel 803 by the syringe 804.

### Embodiment 9

As shown in FIG. 10, one end of the capillary 1001 is inserted into the tubes A as a sample tip. Tubes A containing sample 1002, washing buffer 1003 and reagent for DNA denature 1004 are arranged alternately. Another end of the capillary 1001 is connected with a reservoir 1005 and the solution is flowing along the capillary 1001 with the gravity as driving force. The probe array 1007 has already immobilized on the inner wall of capillary 1001, sample 1002 is introduced to flow through the capillary 1001 and hybridizes with the probe array 1007, washing the capillary 1001 with washing buffer 1003 and get detected. Reagent for denature 1004 flows through the capillary 1001 and denatures the hybridized sample, then the probe array 1007 is regenerated. Repeat above steps to realize multiple samples detection.

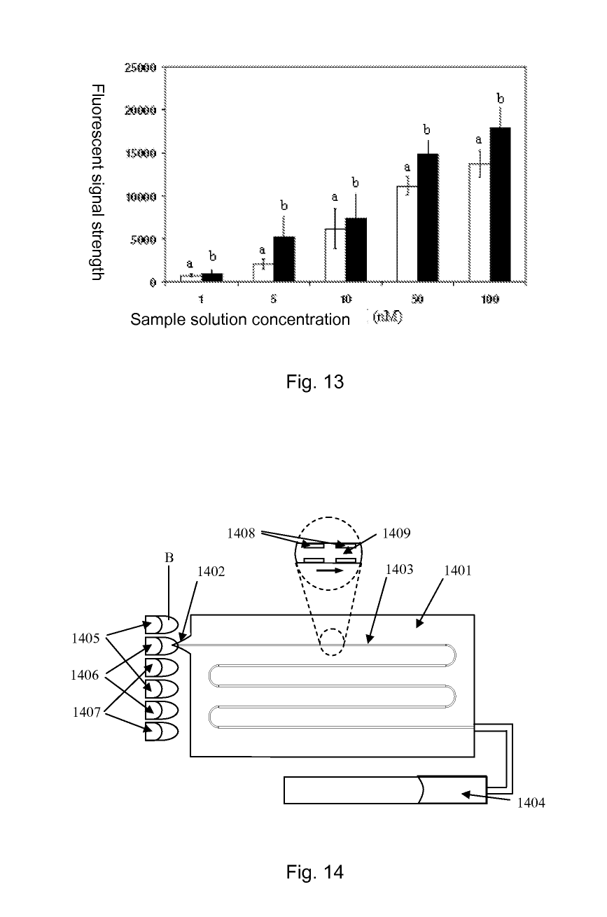

The FIG. 13 is the fluorescence intensity of hybridization results. Two samples with different concentrations hybridize with the probe array 1007 inside the capillary 1001.

### Embodiment 10

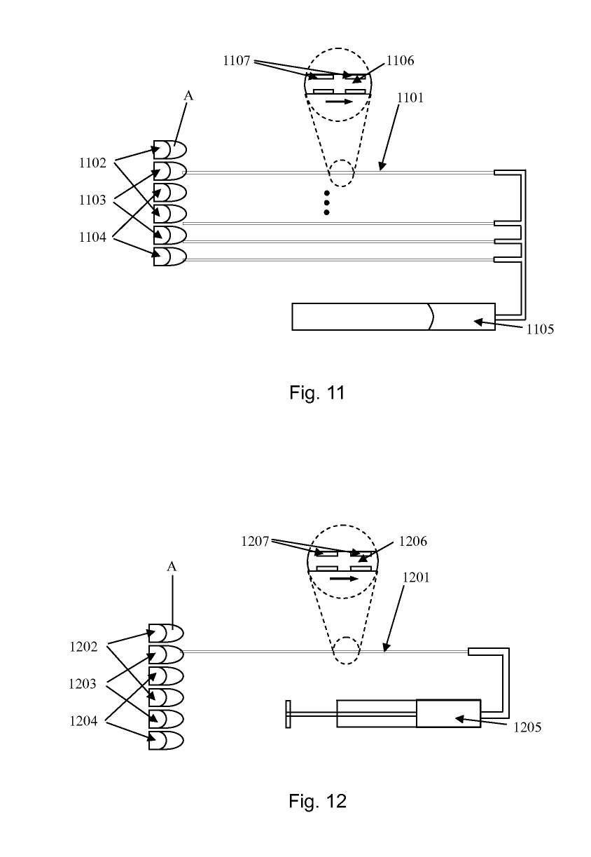

As shown in FIG. 11, the capillary array 1101 consists of parallel capillary. Each capillary has one inlet and one outlet, and is used for parallel biochip analysis.

### Embodiment 11

As shown in FIG. 12, the outlet of capillary 1201 is connected with a syringe 1205. The sample is driven flowing through the capillary 1201 by the syringe 1205.

### Embodiment 12

As shown in FIG. 14, the microfluidic chip 1401 has a serpentine microchannel 1403. The inlet 1402 of the microchannel 1403 is machined into a sharp needle, and inserted into the tubes B as a sample tip, tubes B containing sample 1405, washing buffer 1406 and reagent for DNA denature 1407 are arranged alternately. The outlet of the microchannel 1403 is connected with a reservoir 1404 and the solution is flowing along the microchannel 1403 with the gravity as driving force. The probe array 1408 has already immobilized onto the microchannel 1403 of microfluidic chip 1401, sample 1405 is introduced to flow through the microchannel 1403 and hybridizes with the probe array 1408, washing the microchannel 1403 with washing buffer 1406 and get detected. Reagent for denature 1407 flows through the microchannel 1408 and denatures the hybridized sample, then the probe array 1408 is regenerated. Repeat above steps to realize multiple samples detection.

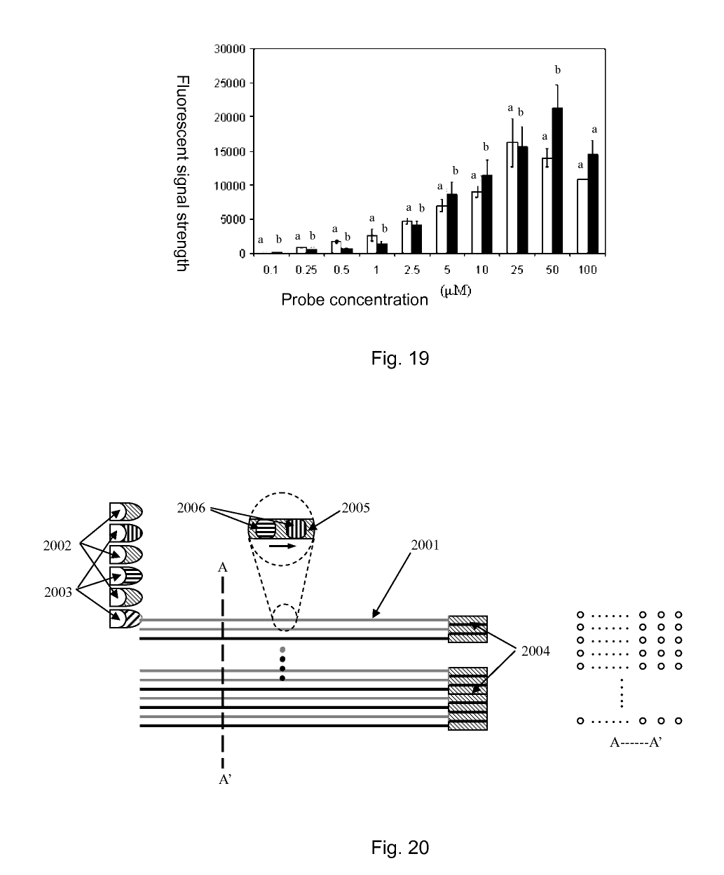

FIG. 19 illustrates the fluorescence intensity of hybridization results. The probe arrays with different concentrations are immobilized and two samples hybridize with the probe arrays 1408.

### Embodiment 13

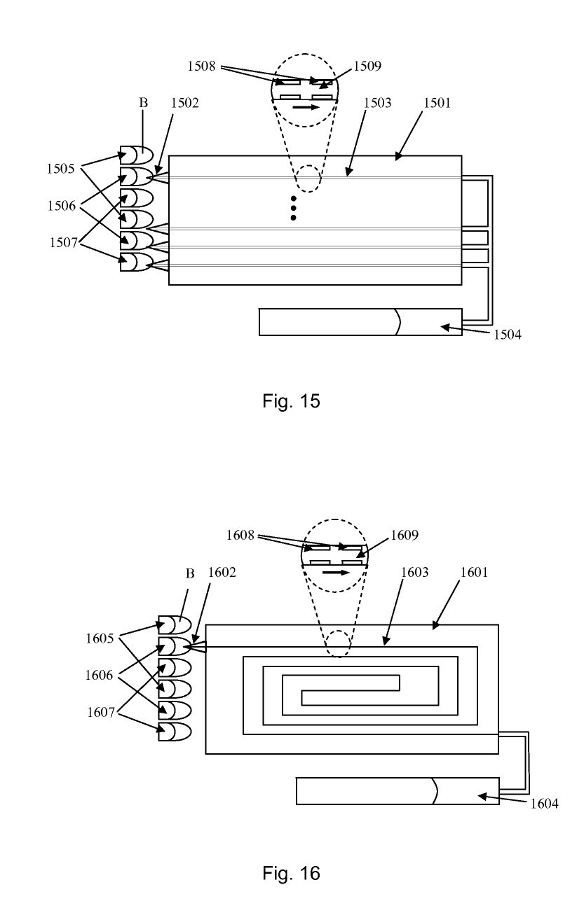

As shown in FIG. 15, the microfluidic chip 1501 is consisted of one or multiple parallel microchannels 1503. Each microchannel 1503 has one inlet and one outlet, and is used for parallel biochip analysis.

### Embodiment 14

As shown in FIG. 16, the spiral microchannel 1603 of microfluidic chip 1601 is used for biochip analysis

### Embodiment 15

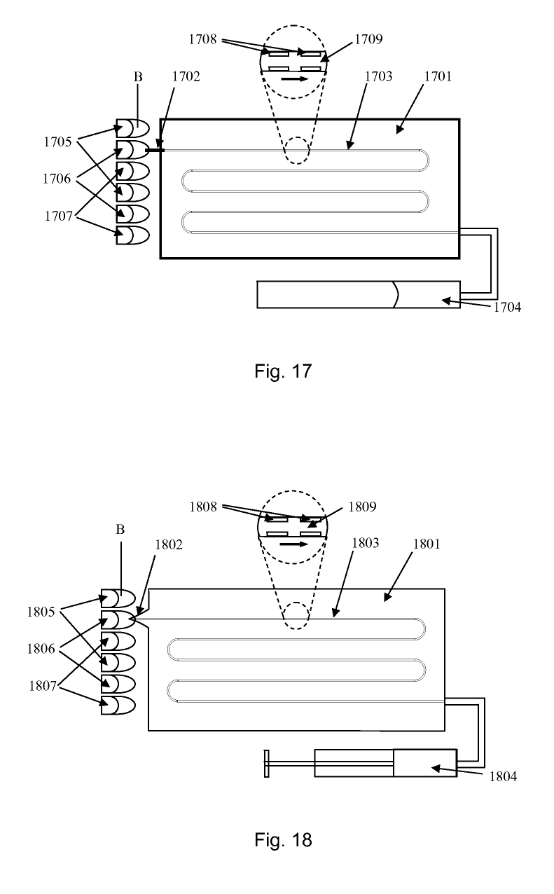

As shown in FIG. 17, the inlet of microchannel 1703 is replaced by a short capillary 1702, and used for biochip analysis. The method is listed below: drill a small hole at the inlet of microchannel 1703, then insert a short capillary 1702 into the hole and fix with glue.

### Embodiment 16

As shown in FIG. 18, the outlet of microchannel 1803 is connected with a syringe 1804. The sample is driven flowing through the microchannel 1803 by the syringe 1804.

### Embodiment 17

As shown in FIG. 20, a three-dimensional array is consisted of multiple parallel capillaries 2001. Each capillary has one inlet and one outlet, parallel probe arrays are prepared in the capillaries and used for biochip analysis.

### Embodiment 18

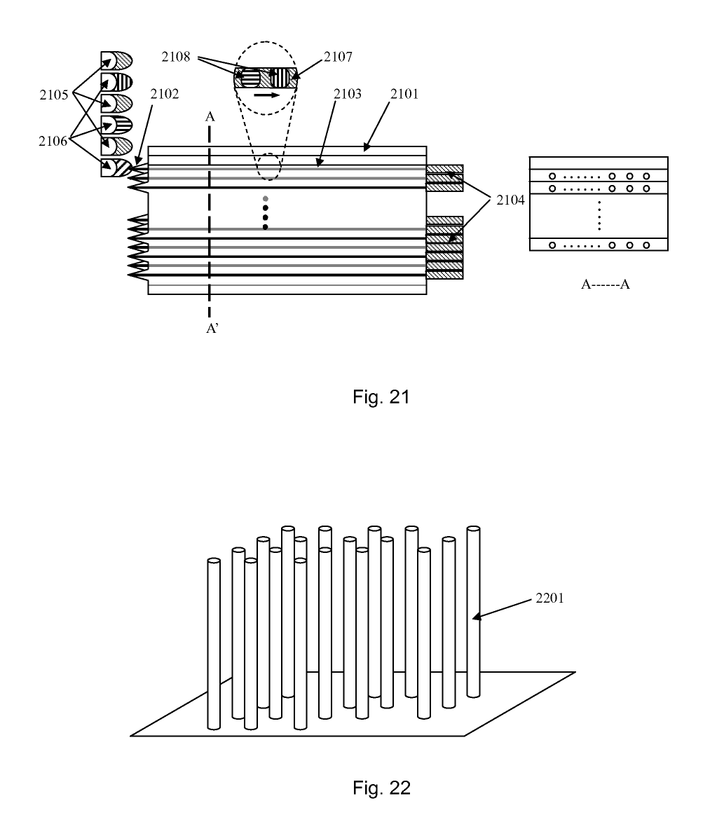

As shown in FIG. 21, a three-dimensional array is consisted of multiple microfluidic chips 2101, each microfluidic chip 2101 has one or multiple parallel microchannels 2103. Probe arrays are prepared in the microchannels 2103 and used for biochip analysis.

### Embodiment 19

As shown in FIG. 22, an array is consisted of standing capillaries 2201, multiple parallel probe arrays are prepared along the capillaries 2201 and used for biochip analysis.

### Embodiment 20

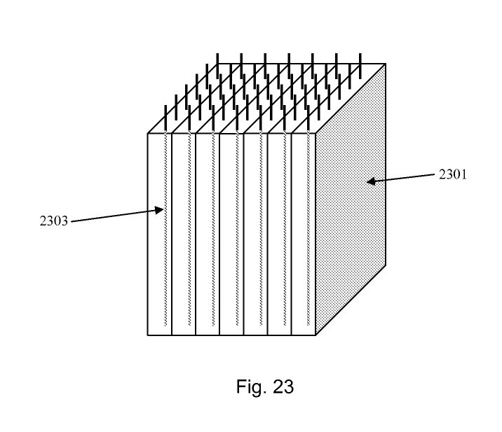

As shown in FIG. 23, an array is consisted of standing microfluidic chips 2301, each microfluidic chip has one or multiple parallel microchannels 2303. Multiple parallel probe arrays are prepared along the microchannels 2303 and used for biochip analysis.

Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

What is claimed is:

1. An array of microchannels, comprising:
at least one microchannel; and
a plurality of probes disposed in an inner wall of the microchannel forming a one-dimensional array,
wherein the one-dimensional array of probes are configured to react with a sample in the microchannel.

2. The array of claim 1, wherein the array comprises a plurality of microchannels forming a two-dimensional array of probes.

3. The array of claim 2, wherein the two-dimensional probes array form a three-dimensional array of probes, and wherein the multiple microchannels are perpendicular to a same surface.

4. The array of claim 3, wherein the sample comprises a sequence of droplets configured to react respectively with the plurality of probes.

5. The array of claim 4, wherein the sequence of droplets contain different types of samples, wherein the at least one microchannel comprises different probes, and wherein the sequence droplets and the different probes are configured to have one-to-one mapping in the microchannel.

6. The array of claim 1, wherein the microchannel comprises a microfluidic channel or a capillary channel.

7. The array of claim 1, wherein the probes and the sample comprise at least one of nucleic acids, oligonucleotides, proteins, peptides, peptide-nucleic acids, oligosaccharides, antigens, immunoglobulins, ligand, receptor, drug, cells, organelles, cell fragments, small molecules, and chimeric molecules.

8. The array of claim 1, wherein the microchannel is composed of glass, polymer, or semiconductor.

9. A biochip comprising:
a plurality of microchannels; and
a plurality of probes disposed in an inner wall of each of the plurality of microchannels forming a one-dimensional array,
wherein the one-dimensional array of probes are configured to react with a sample in the microchannel, and
wherein the plurality of microchannels are arranged such that the plurality of probes of the plurality of microchannels form a two-dimensional or three-dimensional array.

10. The biochip of claim 9, wherein the plurality of microchannels comprise at least one of a microfluidic channel or a capillary channel.

11. The array of claim 9, wherein the probes and the sample comprise at least one of nucleic acids, oligonucleotides, proteins, peptides, peptide-nucleic acids, oligosaccharides, antigens, immunoglobulins, ligand, receptor, drug, cells, organelles, cell fragments, small molecules, and chimeric molecules.

12. The biochip of claim 9, wherein the microchannel is composed of glass, polymer, or semiconductor.

13. A method comprising:
introducing an array of probes droplets into a microchannel from an inlet of a microchannel;
immobilizing the probes onto an inner surface of the microchannel to form a one-dimensional array of probes; and
flowing a sample solution through the microchannel to hybridize with the probes.

14. The method of claim 13, wherein said immobilizing comprises washing and drying.

15. The method of claim 13, wherein said flowing a sample solution comprises hybridization between the sample solution with respective probes.

16. The method of claim 13, further comprising de-associating and eliminating the hybridized sample by denaturation.

17. The method of claim 13, further comprising flowing another sample solution through the microchannel and re-hybridizing with a re-generated probes array.

18. The method of claim 13, wherein at least one of said introducing or said flowing is based on a microfluidic pumping action or a capillary action.

19. The method of claim 13, wherein said introducing comprises introducing the array of probes droplets separated by an immiscible solvent.

20. The method of claim 13, wherein the immiscible solvent comprises an organic solution or ionic liquid.
